(19) United States
(12) Patent Application Publication
(10) Pub. No.: US 2026/0011477 A1
(43) Pub. Date: Jan. 8, 2026

(54) ACTUATOR FOR CAMERA

(71) Applicant: JAHWA electronics Co., Ltd., Chungcheongbuk-do (KR)

(72) Inventors: SANG HWA LEE, Chungcheongbuk-do (KR); HONG SEONG KIM, Chungcheongbuk-do (KR); BYEONG JAE PARK, Chungcheongbuk-do (KR); TAE YEON YUN, Chungcheongbuk-do (KR)

(21) Appl. No.: 19/256,252

(22) Filed: Jul. 1, 2025

(30) Foreign Application Priority Data
Jul. 2, 2024 (KR) 10-2024-0086623

(51) Int. Cl. H01F 7/16; G03B 5/00; G03B 13/36; H01F 7/08

(52) U.S. Cl. CPC H01F 7/16; G03B 5/00; G03B 13/36; H01F 7/081; G03B 2205/0046; G03B 2205/0069

(57) ABSTRACT

An actuator for a camera according to an embodiment includes a carrier having a first magnetic body and performing a linear movement, a housing configured to support the linear movement of the carrier, and a second magnetic body provided in the housing to face the first magnetic body and configured to generate an attractive force with the first magnetic body. The second magnetic body includes a first part configured to face the first magnetic body when the carrier is located at an upper portion or a lower portion based on a movement direction of the carrier, and a second part which is a middle portion of the second magnetic body based on the movement direction of the carrier, and a magnetic force between the first magnetic body and the first part is smaller than a magnetic force between the first magnetic body and the second part.

### CROSS-REFERENCE TO RELATED APPLICATION AND CLAIM OF PRIORITY

This application claims the benefit under 35 USC § 119 of Korean Patent Application No. 10-2024-0086623 filed on Jul. 2, 2024, in the Korean Intellectual Property Office, the entire disclosure of which is incorporated herein by reference for all purposes.

### BACKGROUND

### 1. Technical Field

The present disclosure relates to an actuator for a camera, and more specifically, to an actuator for a camera, which may effectively suppress noise generation due to collision or the like of a carrier.

### 2. Background Art

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

Recently, mobile devices are equipped with a zoom lens having specifications capable of variably adjusting the focal length or capturing images from a distance.

Since the zoom lens has a structure in which multiple lenses or groups of lenses are arranged side by side or the lens itself is long in the optical axis direction, a larger mounting space must be provided in the mobile terminal.

Recently, an actuator or camera module having a physical structure that refracts light from a subject by using a reflector disposed at the front end of the lens has been disclosed in order to organically integrate the physical characteristics of such a zoom lens into the morphological characteristics of portable terminals.

In case of the actuator, a carrier moving in the optical axis direction through AF or zoom control may be equipped with a lens that has a long travel distance (stroke) and heavy weight.

Meanwhile, if an external force such as an external shock or shaking is applied to the actuator, a physical shock may occur between the housing (case, base, etc.) of the actuator and the carrier, which are physically separated.

The internal components of the actuator vary in structure and shape, and are made of different materials such as plastic and metal. In the case of an actuator with specifications such as heavy weight and long stroke, the physical impact is greater, so noise increases, and also wear, damage, and destruction of the internal components may occur more easily and significantly.

If wear, damage, etc. occurs to internal components, the possibility of malfunction increases, and foreign substances such as particles and debris detached from internal components may be generated and scattered, which may reduce operating precision and significantly affect image quality, such as the generation of dead pixels in image pickup devices such as CCDs.

To solve these problems, a damper made of a material such as rubber, foam rubber, Poron, or foam resin is provided as a type of cushioning member that may cushion the impact on the object that may experience a physical collision.

However, in the case of an actuator with the specifications described above, since a strong impact or collision occurs, the effectiveness of shock mitigation and noise suppression by the damper may not be high. In addition, if the damper is continuously exposed to external impact, the stress in the damper may accumulate and be concentrated, which may cause plastic deformation in which the damper permanently loses the designed level of elasticity. Also, in the case of a damper with high rigidity, cracks may occur in the damper itself or physical damage or wear may occur.

In this case, the damper cannot perform its original function, so the actuator is exposed to various problems caused by external impact.

### SUMMARY

The present disclosure is designed to solve the problems of the related art, and therefore the present disclosure is directed to providing an actuator for a camera, which may reduce the intensity of collision and minimize the occurrence of collision by applying a reverse return force to the end of the moving area (stroke) of a mover, where the mover collides with a stator, by utilizing the differential magnetic force between a magnet and a yoke plate.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

An actuator for a camera according to an embodiment of the present disclosure may comprise a carrier having a first magnetic body and performing a linear movement; a housing configured to support the linear movement of the carrier; and a second magnetic body provided in the housing to face the first magnetic body and configured to generate an attractive force with the first magnetic body.

The second magnetic body of the present disclosure may include a first part configured to face the first magnetic body when the carrier is located at an upper portion or a lower portion based on a movement direction of the carrier; and a second part which is a middle portion of the second magnetic body based on the movement direction of the carrier. In this case, a magnetic force between the first magnetic body and the first part of the present disclosure may be smaller than a magnetic force between the first magnetic body and the second part.

Preferably, an area of the first part facing the first magnetic body of the present disclosure may be smaller than an area of the second part facing the first magnetic body.

In addition, the first part of the present disclosure may include an open portion that does not generate a magnetic force with the first magnetic body.

Specifically, the first part of the present disclosure may include a first upper part which is a top portion of the second magnetic body; and a first lower part which is a bottom portion of the second magnetic body.

In this case, the first upper part of the present disclosure may be formed in a shape that gets smaller as it goes up, and the first lower part is formed in a shape that gets smaller as it goes down.

Preferably, a total length of the second part based on the movement direction of the carrier may be less than or equal to a total length by which the first magnetic body is physically movable and may be greater than or equal to a total length by which the first magnetic body moves by AF or zoom control.

In addition, the actuator according to an embodiment of the present disclosure may further comprise a driving magnet provided in the carrier; a driving coil provided in the housing to face the driving magnet; and a ball arranged between the housing and the carrier.

In this case, the first and second magnetic bodies may be arranged to face each other with the ball interposed therebetween.

According to a preferred embodiment of the present disclosure, collision or impact between a mover and a stator may be mitigated, thereby more effectively suppressing unnecessary noise generation.

In particular, in the present disclosure, rather than using physical materials to alleviate the collision, the collision between the mover and the stator may be suppressed or minimized using a non-contact method that utilizes magnetic forces with differential sizes.

In this respect, in the present disclosure, the generation of foreign substances, etc. during the process of collision mitigation, absorption, etc. may be significantly reduced, and through this, the operating precision of the actuator may be further improved.

In addition, if a physical shock-absorbing means such as a damper is applied together, the shock or stress applied to the damper may be reduced, which may more effectively induce continuous use of the damper and more effectively prevent fatigue destruction of the damper, plastic deformation of the damper due to stress concentration and accumulation, etc.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIGS. 1 and 2 are diagrams showing the overall configuration of an actuator for a camera according to a preferred embodiment of the present disclosure and a camera module,

FIGS. 3 and 4 are exploded views showing the detailed configuration of the actuator for a camera according to a preferred embodiment of the present disclosure,

FIG. 5 is a drawing for illustrating the operating relationship in which a reflector rotates in the first direction,

FIG. 6 is a drawing for illustrating the operating relationship in which the reflector rotates in the second direction,

FIG. 7 is a drawing showing the overall configuration of an actuator equipped with a yoke plate according to a preferred embodiment of the present disclosure,

FIG. 8 is a drawing showing the detailed configuration of an actuator according to an embodiment of the present disclosure,

FIGS. 9 and 10 are drawings for illustrating the positional relationship between a fourth magnet and a yoke plate,

FIG. 11 is a drawing for illustrating the structure of the yoke plate according to an embodiment of the present disclosure,

FIG. 12 is a drawing for illustrating the relationship between the fourth magnet and the yoke plate,

FIG. 13 is a drawing showing a yoke plate according to other embodiments of the present disclosure,

FIG. 14 is a drawing for illustrating an actuator according to another embodiment of the present disclosure, and

FIG. 15 is a drawing for illustrating the yoke plate shown in FIG. 14.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

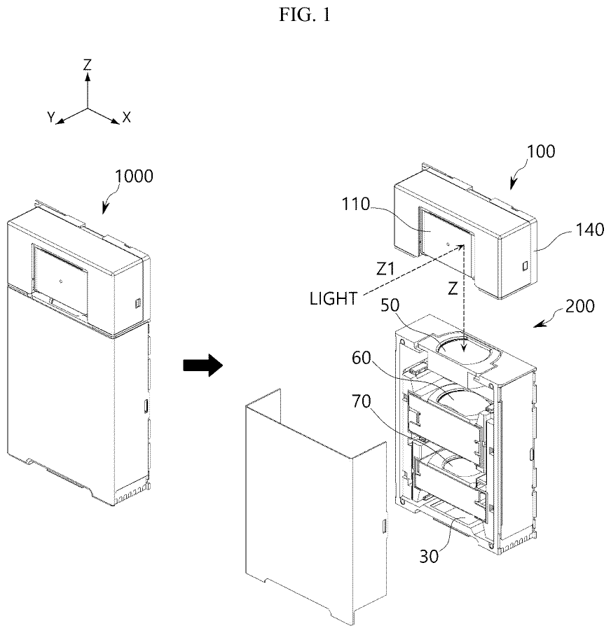

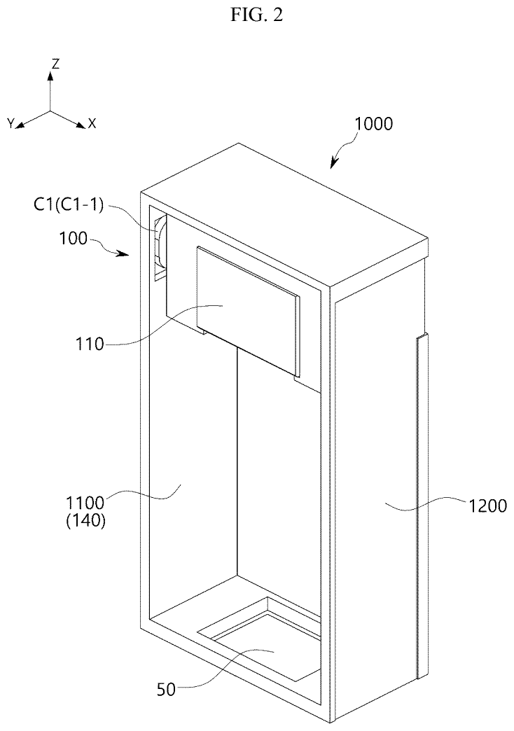

FIGS. 1 and 2 are diagrams showing the overall configuration of an actuator 100 for a camera (hereinafter referred to as “actuator”) according to a preferred embodiment of the present disclosure and a camera module 1000 including the actuator.

The actuator 100 of the present disclosure may be implemented as a standalone device, and as shown in FIG. 1, etc., may be implemented in the form of a camera module 1000 including at least one lens 50, 60, 70, a lens driving module 200 implementing zoom or/and auto focus (AF), and an image sensor 30.

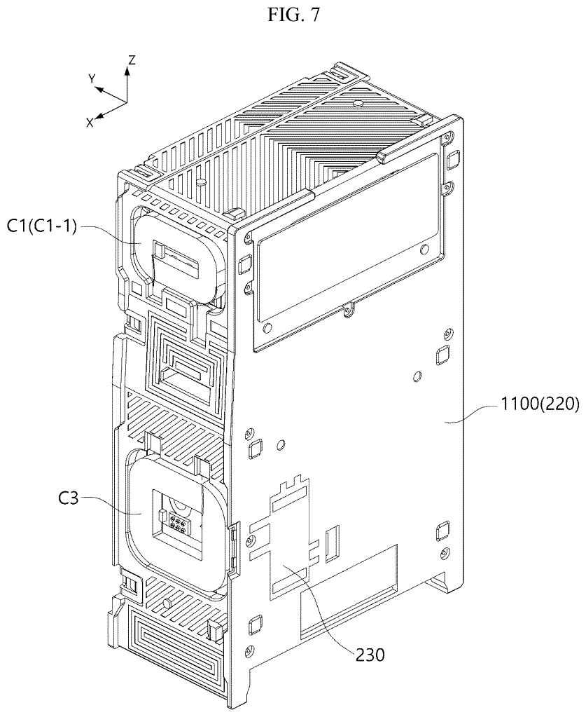

According to an embodiment, the actuator 100 of the present disclosure may be implemented with a form including a lens driving module 200 or with only an actuator 200 that moves a carrier, which is a mover, in the optical axis direction by an AF or zoom function, as described with reference to FIG. 7 and the drawings thereafter.

In the actuator 100 of the present disclosure, the light of a subject is not directly introduced into the lenses 50, 60, 70, but is configured such that the path of light is changed (refracted, reflected, etc.) through the reflector 110 provided in the actuator 100 of the present disclosure and then introduced into the lenses 50, 60, 70.

As illustrated in FIG. 1, the path of light coming from the outside is Z1, and the path of light that is refracted or reflected by the reflector 110 and enters the lenses 50, 60, 70 is Z.

In the following description, the Z-axis direction corresponding to the direction in which light enters the lenses 50, 60, 70 is referred to as the optical axis or optical axis direction, and the two directions perpendicular thereto are referred to as the X-axis and the Y-axis.

An image sensor 30, such as a CCD or CMOS, that converts a light signal into an electric signal may be provided at the rear end of the lenses 50, 60, 70 based on the optical axis direction, and a filter that blocks or transmits a specific band of light signals may be provided together. Of course, the number and positions of lenses 50, 60, 70 may differ from those illustrated in the drawings depending on the embodiment.

As described in detail below, the actuator 100 of the present disclosure corresponds to a device that implements OIS for the X-axis direction or/and the Y-axis direction by rotating the reflector 110 in a direction that compensates for the movement when shaking due to hand tremors, etc. occurs with respect to the X-axis direction or/and the Y-axis direction perpendicular to the optical axis.

As illustrated in FIG. 1, the actuator 100 of the present disclosure may be implemented as an independent device and coupled with another device constituting the camera module 1000, and may also be implemented in various forms, including a form included within the housing 1100 of the camera module 1000, as illustrated in FIG. 2, etc.

In this case, the housing 140, which is a component of the actuator 100, may be the housing of the actuator 100 itself or the housing 1100 of the camera module 1000.

It is obvious that the axes depicted in the drawings, terms referring to the axes, and terms such as upper portion, lower portion, front, rear, vertical, horizontal, etc., described with respect to the axes are only intended to present relative standards for describing embodiments of the present disclosure, and are not intended to specify any direction or position on an absolute basis, and may of course vary relatively depending on the position of the target object, the position of the observer, the view direction, etc.

In the following description, the present disclosure will be described with the Z-axis as the reference for the up-down or vertical direction, and, from a corresponding viewpoint, the present disclosure will be described with the Y-axis as the reference for the front or rear, and the X-axis as the reference for the left or right.

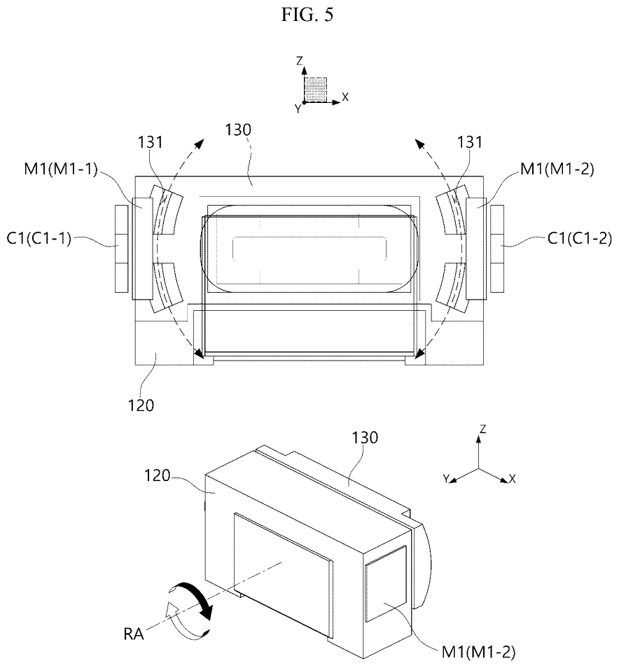

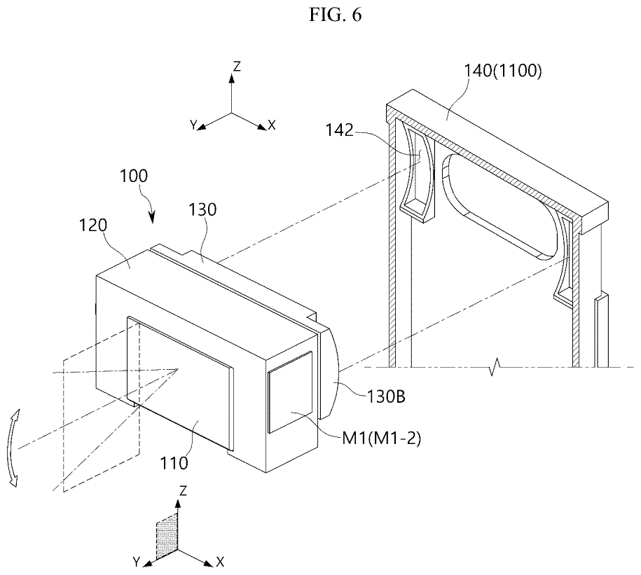

With the actuator 100 according to an embodiment of the present disclosure as a reference, as described below, the XZ plane or a plane corresponding thereto becomes a plane direction in which the carrier 120 rotates with the middle guide 130 as a relative stator (see FIG. 5), and the YZ plane becomes a plane direction in which the middle guide 130 of the present disclosure rotates together with the carrier 120 with the housing 140, 1100 as a reference (see FIG. 6).

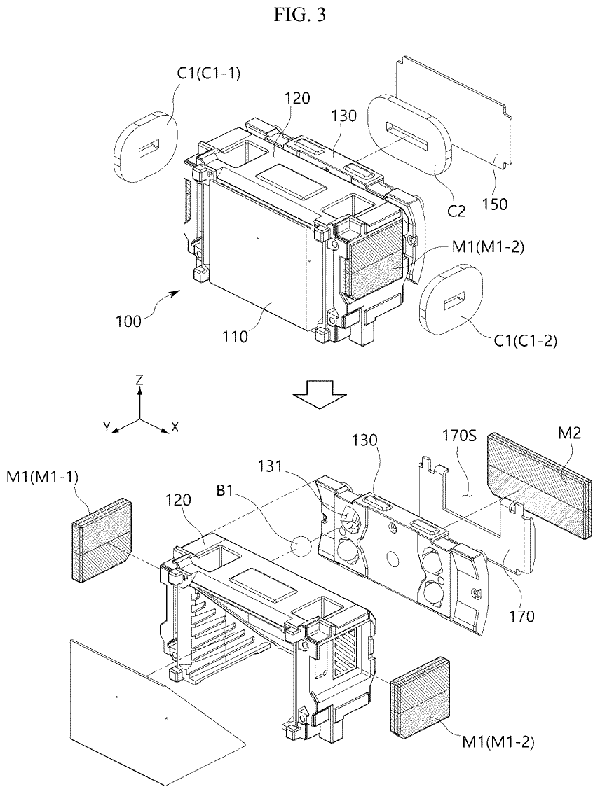

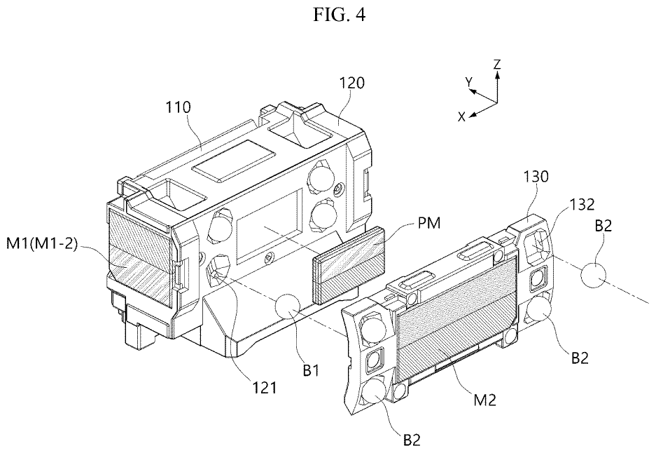

FIGS. 3 and 4 are exploded views showing the detailed configuration of the actuator 100 according to a preferred embodiment of the present disclosure,

As illustrated in FIG. 3, the actuator 100 according to an embodiment of the present disclosure may include a reflector 110, a carrier 120, a middle guide 130, and a housing 140. As described above, the housing 140 of the actuator 100 may be the housing 1100 of a camera module 1000 or the housing of a device in which the lens driving module 200 is integrated.

First, the overall configuration of the actuator 100 will be described with reference to the drawings, and the detailed configuration and driving relationship of the actuator 100 for OIS operation in each direction will be described later.

As described above, if light of a subject, which is incident along a Z1 path, is introduced into the actuator 100 of the present disclosure, the reflector 110 of the present disclosure changes the path of the light to the optical axis direction Z (by refracting, reflecting, etc.) and introduces the light toward the lens 50, 60, 70.

The reflector 110 may be one selected from a mirror and a prism, or a combination thereof, and may further be implemented with various elements capable of changing light coming from the outside into the optical axis direction.

Since the present disclosure is configured so that the path of light is refracted by the reflector 110 and then introduced into the lenses 50, 60, 70 as above, the lens driving module 200 itself does not need to be installed in the thickness direction of the mobile terminal (such as a smart phone). Therefore, even if an optical member having a long physical characteristic in the optical axis direction, such as a zoom lens, is mounted on the mobile terminal, the thickness of the mobile terminal does not increase, which may be optimized for miniaturization of the mobile terminal.

As is well known, OIS operation is implemented by moving a lens, etc. in a direction that compensates for shaking caused by hand tremors. However, in the embodiment to which the present disclosure is applied, OIS is operated by moving the reflector 110, unlike the method of reversely moving a lens, etc.

The reflector 110 of the present disclosure is installed in a direction in which light enters the actuator 100, that is, in a direction facing the front in the Y-axis direction, and is fixedly installed on the carrier 120, so the reflector 110 physically moves together with the carrier 120.

If the carrier 120 of the present disclosure rotates (based on the XZ plane) relative to the middle guide 130 (as a relative stator), or if the middle guide 130 of the present disclosure rotates (based the YZ plane) relative to the housing 140 (as a relative stator) together with the carrier 120, the reflector 110 installed on the carrier 120 also rotates in the same direction.

Preferably, the first ball B1 may be disposed between the carrier 120 and the middle guide 130, and the second ball B2 may be disposed between the middle guide 130 and the housing 140.

In the case where such balls B1, B2 are intervened, the mover may perform more flexible linear movement due to minimized friction caused by the rolling, moving, rotation, and point-contact of the balls, and it may have the advantages of reduced noise, minimized driving force, and improved driving precision.

As described below, if the carrier 120 equipped with the reflector 110 rotates based on the XZ plane with the middle guide 130 as a relative stator (see FIG. 5), the path of light entering the image sensor 30 moves in the X-axis direction due to the rotational movement of the reflector 110, thereby correcting the hand tremors in the X-axis direction.

In addition, if the carrier 120 equipped with the reflector 110 rotates based on the YZ plane together with the middle guide 130 (see FIG. 6), the path of light entering the image sensor 30 moves in the Y-axis direction due to the rotational movement of the reflector 110, thereby correcting the hand tremors in the Y-axis direction.

In the following description, regarding the image stabilization in the X-axis direction, the direction in which the reflector 110 rotates in a plane corresponding to the XZ plane is referred to as the ‘first direction’, and regarding the image stabilization in the Y-axis direction, the direction in which the reflector 110 rotates in a plane corresponding to the YZ plane is referred to as the ‘second direction’.

In this respect, the middle guide 130 of the present disclosure corresponds to a stator in its relative relationship with the carrier 120 for the first direction rotational movement, but corresponds to a mover in its relative relationship with the housing 140 for the second direction rotational movement.

As shown in FIGS. 3 and 4, a second magnet M2 for driving the second direction OIS may be installed in the middle guide 130.

According to an embodiment, the second magnet M2 may be installed in the middle guide 130 with a back yoke 170 interposed therebetween to prevent leakage of the magnetic force and to concentrate the magnetic force so as to strengthen the magnetic force between the second coil C2 and the second magnet M2.

The back yoke 170 installed at the rear of the second magnet M2 and the back yoke 500 provided at the first magnet M1 or the magnet installed on the mover (carrier) moving in the optical axis direction (Z-axis direction) will be described later in detail with reference to FIGS. 7 to 14.

The pulling magnet PM of the present disclosure is a configuration installed on the carrier 120, and is installed in a direction facing the second magnet M2 as illustrated in the drawings. Based on FIG. 4, the pulling magnet PM is installed on the rear surface (based on the Y-axis) of the carrier 120, and based on the middle guide 130, the pulling magnet PM is disposed at the front side (based on the Y-axis) of the middle guide 130.

The pulling magnet PM includes a magnetic pole (hereinafter referred to as a “counter magnetic pole”), which has the opposite polarity to the facing magnetic pole facing the pulling magnet PM among the magnetic poles of the second magnet M2 and faces the facing magnetic pole. This counter magnetic pole is located at a position corresponding to the facing magnetic pole based on the default position (reference position) of the carrier 120.

The pulling magnet PM generates an attractive force on the second magnet M2 to bring the carrier 120 equipped with the pulling magnet PM into close contact with the middle guide 130.

The second magnet M2 is installed in the middle guide 130, and the pulling magnet PM is installed in the carrier 120. Therefore, when an attractive force occurs between the pulling magnet PM and the second magnet M2, the carrier 120 is pulled toward the middle guide 130, so the carrier 120 and the middle guide 130 with the first ball B1 interposed therebetween are in close contact.

Due to this attractive force relationship, point contact between the first ball B1 and the carrier 120, as well as between the first ball B1 and the middle guide 130, may be continuously maintained.

In addition, even if the carrier 120 rotates based on the XZ plane due to the driving of the first direction OIS, if the OIS driving, etc. is terminated or stopped, the pulling magnet PM restores the position or posture of the carrier 120 to a position or posture at which the facing magnetic pole of the second magnet M2 and the counter magnetic pole of the pulling magnet PM are aligned or face each other in a regular arrangement.

Hereinafter, the detailed configuration and driving relationship of the actuator 100 for OIS driving in each direction will be described with reference to FIGS. 5 and 6, etc.

As shown in the drawings, a first magnet M1 for driving the first direction OIS is installed in the carrier 120 where the reflector 110 is installed. The first magnet M1 may be installed on the left and right sides of the carrier 120, respectively (M1-1, M1-2), as illustrated in the drawings, in order to increase driving efficiency, etc.

In the housing 140, a first coil C1 facing the first magnet M1 is installed. If a plurality of first magnets M1 are installed, a plurality of first magnets first coils C1 (C1-1, C1-2) may also be installed.

If power of an appropriate magnitude and direction is applied to the first coil C1 through the control of the operation driver (not shown) to generate a magnetic force between the first coil C1 and the first magnet M1, the carrier 120 rotates through the guiding of the first ball B1 in a state of facing the middle guide 130 plane-to-plane (see FIG. 5), and the X-axis direction OIS, i.e., the first direction OIS, is implemented by this rotational movement. In this case, the rotation axis RA for the first direction OIS corresponds to the Y-axis.

As shown in the drawings a first ball B1 is disposed between the carrier 120 and the middle guide 130. The first ball B1 may be disposed in a form in which apart thereof is accommodated between the first rail 131, which is provided on a surface of the middle guide 130 facing the carrier 120 and has a rounded shape (e.g., a track shape), and the first guider 121 provided on the carrier 120.

One of the first rail 131 and the first guider 121 may be implemented as a rail shape with a continuous or partially continuous groove, and may also be implemented as a pocket shape that prevents external escape of the first ball B1.

Depending on the embodiment, a detection sensor may be further included in the configuration for driving control of the OIS. In this case, if the detection sensor detects the position of the carrier 120 (specifically, the first magnet M1 or the sensing magnet installed in the carrier 120) and transmits a corresponding signal to the operation driver, the operation driver controls power of a corresponding magnitude and direction to be applied to the first coil C1.

The detection sensor may be implemented as a hall sensor that detects the change in magnitude and direction of the magnetic field of a magnet within a detection area using the hall effect and outputs an electrical signal accordingly.

From a corresponding viewpoint, if power of an appropriate magnitude and direction is applied to the second coil C2 through control of the operation driver (not shown), a magnetic force is generated between the second coil C2 and the second magnet M2, and the generated magnetic force acts as a driving force to rotate the middle guide 130 (as a relative stator) in the second direction with respect to the housing 140 together with the carrier 120 (see FIG. 6).

In addition, as shown in the drawings, a second rail 132 having a rounded shape is provided on the rear surface 130B (based on the Y-axis) of the middle guide 130, and a second guider 142 is provided on the housing 140 facing the rear surface of the middle guide 130.

In this case, the second ball B2 may be disposed between the second rail 132 and the second guider 142. Of course, the second rail or/and the second guider 142 may be formed in a shape in which a groove portion is extended to accommodate a portion of the second ball B2 as illustrated in the drawings, or in a pocket shape to prevent external escape of the second ball B2.

The yoke plate 150 is provided in the housing 140, which functions as a relative stator for the second direction movement of the middle guide 130, and generates an attractive force with the second magnet M2 installed in the middle guide 130.

By the attractive force between the yoke plate 150 and the second magnet M2, point contact between the middle guide 130 and the second ball and between the second ball B2 and the housing 140 may be continuously maintained.

Since the middle guide 130 is in close contact with the housing 140 by the attractive force of the yoke plate 150 in this way and the second rail 132 with the second ball B2 interposed therebetween and the second guider 142 face each other, if a magnetic force is generated between the second coil C2 and the second magnet M2, the middle guide 130 rotates (second direction rotation) along the rounded shape of the second rail 132 and/or the second guider 142 with the second ball B2 interposed therebetween.

When the first direction rotation is driven, the middle guide 130 of the present disclosure functions as a stator in a relative relationship with the carrier 120 and supports the first direction rotational movement of the carrier 120.

When the second direction rotation is driven, the housing 140 of the present disclosure functions as a stator in a relative relationship with the middle guide 130 and supports the second direction rotational movement of the middle guide 130.

The first rail 131 formed on the middle guide 130 may be formed in a rounded shape like a track with respect to the XZ plane, as illustrated in the drawings, so that the first direction rotational movement of the carrier 120 is guided. The second rail 132 may be formed in a rounded shape with respect to the YZ plane so that the second direction rotational movement of the middle guide 130 is guided together with the carrier 120.

The first rail 131 and the second rail 132 are formed in directions perpendicular to each other, and the second ball B2 is disposed to be accommodated between the second rail 132 and the second guider 142. Therefore, when the carrier 120 rotates in the first direction with the middle guide 130 as a relative stator through the guiding of the first rail 131, etc., the second rail 132, the second ball B2, and the second guider 142, etc. function as physical structures that suppress the rotational movement of the middle guide 130.

Due to this structural relationship, even if a magnetic force (electromagnetic force) is generated between the first magnet M1 and the first coil C1, the middle guide 130 may maintain a fixed position in relation to the housing 140.

In a corresponding viewpoint, when a driving force is generated on the second magnet M2 by the magnetic force between the second magnet M2 and the second coil C2, the middle guide 130 rotates in the second direction (YZ plane) through the guiding of the second rail 132, the second guider 142, and the second ball B2 interposed therebetween.

In this case, the carrier 120 is maintained at a fixed position in relation to the middle guide 130 by the restraining structure of the first rail 131, the first ball B1, and the first guider 121, and thus rotates in the second direction together with the middle guide 130.

The first coil C1, the second coil C2, the hall sensor, the operation driver, etc. may be mounted on the circuit board 1200 installed in the camera module 1000 or on the circuit board provided in the actuator 100 itself. The circuit board 1200 is preferably configured so that a portion thereof is exposed to the outside for interfacing with external modules, a power supply, external devices, etc.

The first guider 121 and the first rail 131, together with the first ball B1, perform the function of physically supporting and guiding the movement of the carrier 120, which rotates relative to the middle guide 130 as a stator.

Therefore, if the pulling magnet PM is positioned at the middle portion of the rear surface of the carrier 120 and the first guider 121 is provided on the outer side of the pulling magnet PM, the tilt or play of the carrier 120 is minimized, and also the first direction rotation of the carrier 120 may be made more stably.

If a reflector that reflects light of a subject toward the lens can be moved or rotated in the X-axis and Y-axis directions, i.e., in different directions, a mover having a different physical structure from the embodiment of the present disclosure described with reference to FIGS. 1 to 6 may also be applied.

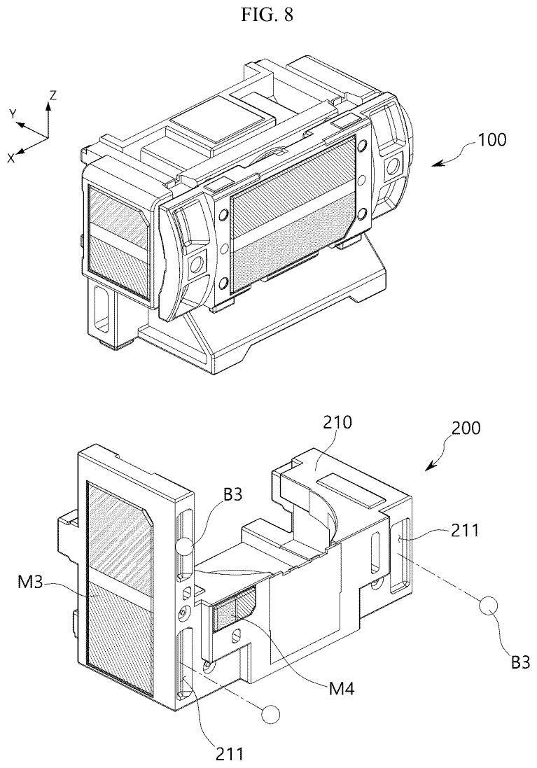

FIG. 7 is a drawing showing the overall configuration of an actuator 200 equipped with a yoke plate 230 according to a preferred embodiment of the present disclosure, and FIG. 8 is a drawing showing the detailed configuration of an actuator 200 according to an embodiment of the present disclosure.

The actuator 200 of the present disclosure may be implemented as a lens driving module 200 alone that moves a lens or the like in a specific direction (optical axis direction) by an AF or zoom function, or may be implemented in a form including the lens driving module 200.

The actuator 200 according to the embodiment of the present disclosure described below corresponds to an actuator that performs linear movement of a lens, etc., by means of an AF or zoom function.

Hereinafter, the detailed configuration of the present disclosure is described based on an embodiment in which the carrier moves in the optical axis direction, but, depending on the embodiment, the movement direction of the carrier may be a direction different from the optical axis direction.

The actuator 200 according to the present disclosure may include a carrier 210 that moves linearly in an optical axis direction (Z-axis direction), a housing 220 that supports movement of the carrier 210 in the optical axis direction, and at least one lens 60, 70 mounted on the carrier 210.

A third magnet M3 facing a third coil C3 is installed in the carrier 210 moving in the optical axis direction, and the third coil C3 is installed in the housing 220, which is a relative stator of the carrier 210. The third magnet M3 is preferably installed in the carrier 210 with a back yoke interposed therebetween to increase magnetic force and reduce leakage magnetic force.

As previously described, the housing 220, which is a component of the actuator 200, may be the housing of the actuator 200 itself, but may also be the housing 1100 of the camera module 1000.

A third ball B3 may be disposed between the carrier 210 and the housing 220. If the third ball B3 is interposed as above, the carrier 210, which is a mover, may perform more flexible linear movement with the housing 220 as a relative stator due to minimized friction caused by the rolling, moving, rotation, and point-contact of the ball, thereby reducing noise, minimizing driving force, and improving driving precision.

The third ball B3 may be arranged in a form in which a portion thereof is accommodated in the rail (not shown) formed on the surface of the housing 220 facing the carrier 210 or/and the third rail 211 formed on the carrier 210 so as to effectively guide the linear movement of the carrier 210.

A second magnetic body 230 provided in the housing 220 and a first magnetic body M4 that generates an attractive force are installed in the carrier 210.

If an attractive force is generated between the first magnetic body M4 and the second magnetic body 230 in this way, the carrier 210 comes into close contact with the housing 220 in a state where the third ball B3 is interposed, so that point contact between the third ball B3 and the carrier 210 and between the third ball B3 and the housing 220 may be continuously maintained.

Both the first magnetic body M4 and the second magnetic body 230 may be magnets if they can generate an attractive force to each other, and it is also possible that one of them is a magnet and the other is made of a magnetic material.

In order to improve the efficiency and driving precision of the molding or assembly process, it is preferable that a magnet (first magnetic body) is provided on the carrier 210 that is a mover and a magnetic body made of magnetic material is provided on the housing 220 that is a relative stator of the carrier 210.

In the following description, based on the above embodiment, the first magnetic body provided in the carrier 210 is referred to as the fourth magnet M4, and the second magnetic body provided in the housing 220 is referred to as the yoke plate 230.

If a current of an appropriate magnitude and direction is supplied to the third coil C3 by an external control signal or an internal algorithm, an electromagnetic force (magnetic force) is generated between the third coil C3 and the third magnet M3, and the carrier 210 equipped with the third magnet M3 moves in the optical axis direction due to the generated electromagnetic force.

In this respect, the third coil C3 is a driving coil that drives the movement of the carrier 210, and the third magnet M3 corresponds to a driving magnet that applies driving force in relation to the third coil C3.

As illustrated in the drawings, the surface (YZ plane based on the drawings) on which the third coil C3 and the third magnet M3 that generate the driving force are installed may be configured to be perpendicular to the surface (XZ plane) on which the yoke plate 230 and the fourth magnet M4 face each other with the third ball B3 interposed therebetween.

In this configuration, the region where the driving force is applied and the region where the physical movement is supported may be separated from each other, which may reduce the load on the physical movement and prevent magnetic interference, thereby improving the driving performance.

Depending on the embodiment, the yoke plate 230 may of course be installed in a direction facing the third magnet M3. In this case, the third magnet M3 may perform both the function of generating a driving force in relation to the third coil C3 and the function of generating an attractive force in relation to the yoke plate 230 to bring it into close contact with the third ball B3.

Therefore, in this embodiment, a separate magnetic body that generates an attractive force with the yoke plate 230 may not be provided.

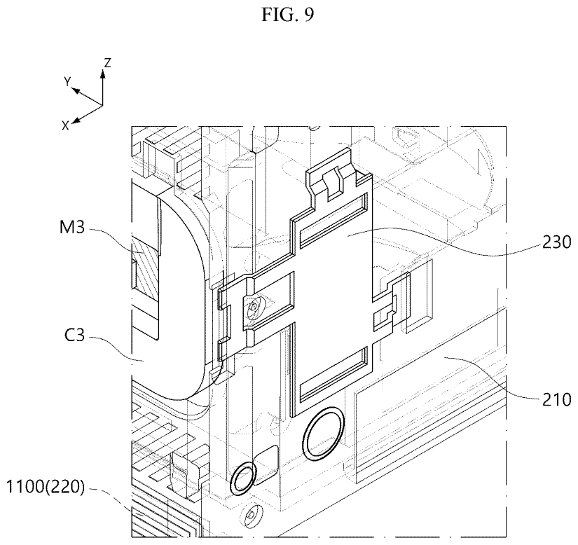

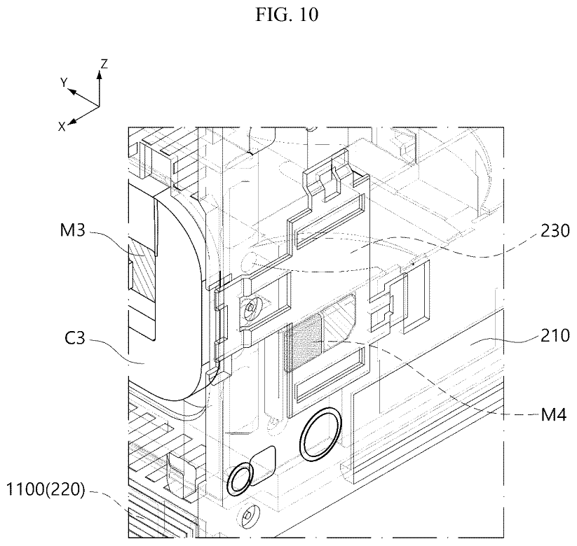

FIGS. 9 and 10 are drawings for illustrating the positional relationship between a fourth magnet M4 and a yoke plate 230.

The carrier 210 of the present disclosure moves in the optical axis direction (Z-axis direction) with the housing 220 as a relative stator. Since the fourth magnet M4 of the present disclosure is installed in the carrier 210, when the carrier 210 is physically moved, the carrier 210 moves in the optical axis direction together with the carrier 210.

The yoke plate 230 of the present disclosure is installed to face the fourth magnet M4 in the housing 220 corresponding to a relative stator of the mover carrier 210 and generates an attractive force with the fourth magnet M4.

Since an attractive force is generated between the fourth magnet M4 and the yoke plate 230 and the third ball B3 is interposed therebetween, when the carrier 210 moves forward and backward in the optical axis direction, the carrier 210 moves in the optical axis direction through the guiding of the third ball B3 while maintaining a state of close contact with the housing 220.

The yoke plate 230 may be configured to have an extended shape based on the optical axis direction so that an attractive force is generated between the fourth magnet M4 and the yoke plate 230 throughout the range in which the fourth magnet M4 moves in the optical axis direction.

The yoke plate 230 of the present disclosure is configured to be fixedly installed to the housing 220, and may be fixedly installed to the housing 220 through various coupling methods such as bonding, and may also be configured to be partially or completely embedded in the housing 220 through insert injection/molding, etc.

It is preferable that one surface of the yoke plate 230 is exposed toward the fourth magnet M4 inside the housing 220 so that the magnetic force with the fourth magnet M4 may be enhanced.

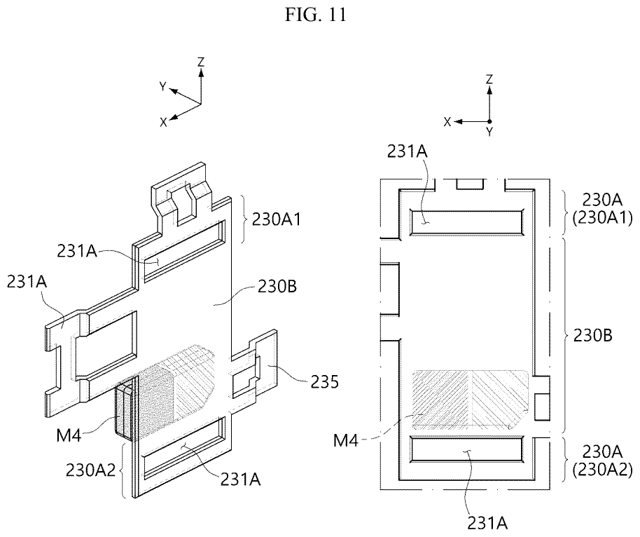

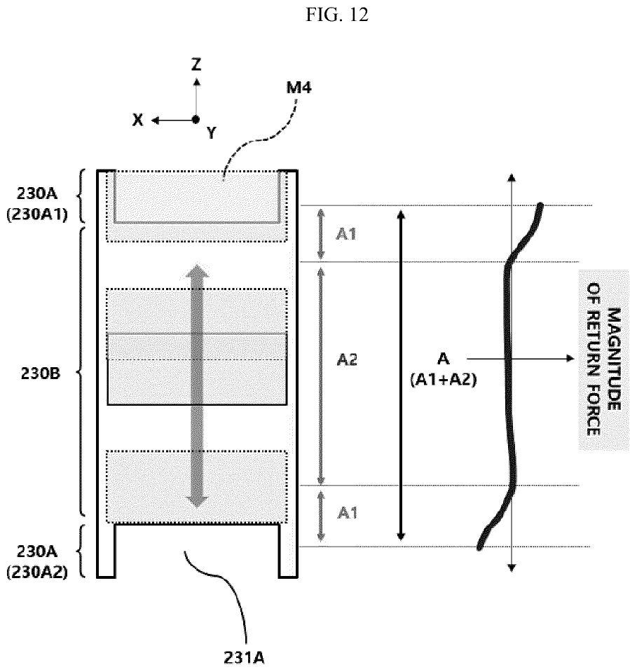

FIG. 11 is a drawing for illustrating the structure of the yoke plate 230 according to an embodiment of the present disclosure, and FIG. 12 is a drawing for illustrating the relationship between the fourth magnet M4 and the yoke plate 230.

As illustrated in FIG. 11, the yoke plate 230 of the present disclosure may include a first part 230A, which is an upper portion or lower portion based on the vertical longitudinal direction (optical axis direction), and a second part 230B, which is a middle portion of the yoke plate 230.

According to an embodiment, the yoke plate 230 of the present disclosure may further include a branch portion 235 as illustrated in the drawings. The branch portion 235 has a shape extending from a side surface of the first part 230A and/or the second part 230B to expand a coupling area with the housing 220, thereby enhancing the fixedly coupling force of the yoke plate 230 to the housing 220.

In addition, the branch portion 235 may be configured to include a stepped shape as illustrated in the drawings. In this configuration, if the yoke plate 230 is physically connected to the housing 220 or a portion thereof is embedded by insert injection, the fixed coupling with the housing 220 may be further strengthened, and play or shaking of the yoke plate 230 may be fundamentally prevented.

If the carrier 210 moves forward or backward along the optical axis direction, the fourth magnet M4 installed on the carrier 210 also moves along with the carrier 210 in the optical axis direction.

If the carrier 210 is located at the upper portion (top, based on the optical axis direction) or lower portion (bottom, based on the optical axis direction) of the moving range of the carrier 210, the first part 230A of the yoke plate 230 refers to an area or range of the yoke plate 230 that faces the fourth magnet M4 installed in the carrier 210 at that location.

The second part 230B of the yoke plate 230 is a middle portion of the yoke plate 230, and refers to an area or range of the yoke plate 230 that faces the fourth magnet M4 installed in the carrier 210 when the carrier 210 is located in the middle portion of the movement range of the carrier 210.

The length (in the optical axis direction) of the first part 230A and/or the second part 230B may be set variously depending on the specifications regarding the range of movement of the carrier 210, the physical range of movement of the carrier 210, the range of movement of the carrier 210 by control (AF, zoom, etc.), etc.

In a conventional actuator, an attractive force is always applied between the magnet equipped in the carrier, which is a mover, and the yoke equipped in the housing (base, etc.), which is a stator, but the attractive force has a direction component that is perpendicular to the optical axis direction (vertical direction), and its size is the same regardless of the position or area of the yoke.

Therefore, if an external force (shaking, vibration, shock, etc.) is applied in the vertical direction to the actuator or the mobile terminal in which the actuator is installed, the attractive force between the yoke and the magnet has difficulty in functioning as a force to offset or suppress the external force.

For this reason, in a conventional actuator, if an external force is applied, the carrier inside the actuator moves up and down with a force corresponding to the external force and collides with the housing, etc., thereby causing the problem mentioned above.

The yoke plate 230 of the present disclosure is a main component of the present disclosure that effectively resolves these problems through simple structural improvements.

Specifically, the yoke plate 230 of the present disclosure is configured such that the magnetic force between the first part 230A of the yoke plate 230 and the fourth magnet M4 is less than the magnetic force between the second part 230B and the fourth magnet M4.

That is, according to the present disclosure, the magnetic force magnitude of the yoke plate 230 is differentiated based on the height direction (optical axis direction) so that the upper portion (top) and/or the lower portion (bottom) have relatively small magnetic forces, and the middle portion has a relatively large magnetic force.

Therefore, if the carrier 210 is positioned at the upper portion or the lower portion (A1, see FIG. 12), a force (returning force) to cause the carrier 210 equipped with the fourth magnet M4 to return to the middle portion of the yoke plate 230 (A2, see FIG. 12) is naturally formed, and this returning force acts in a direction that offsets the external force.

The yoke plate 230 of the present disclosure induces a downward return force to be applied to the carrier 210 moving upward by an external force, thereby suppressing the carrier 210 from colliding with the stator (housing, etc.) or reducing the amount of impact between the carrier 210 and the stator.

From a corresponding viewpoint, if the carrier 210 moves in a downward direction due to an external force, an upward return force by the yoke plate 230 is applied to the carrier 210, so in this case as well, the collision of the carrier 210 with the stator (housing, etc.) is suppressed or minimized.

That is, the return force formed by the embodiment of the present disclosure functions as a force that weakens the external force acting on the carrier 210.

Physical contact or collision between the carrier 210 and the stator (housing, etc.) may occur in both the upper and lower directions (based on the movement direction) depending on the embodiment, and therefore, as illustrated in FIG. 11, the first part 230A may include a first upper part 230A1, which is a top portion of the yoke plate 230 (second magnetic body), and a first lower part 230A2, which is a bottom portion of the yoke plate 230.

The method for making the magnetic force (hereinafter referred to as the ‘first magnetic force’) between the first part 230A and the first magnetic body (fourth magnet M4) be smaller than the magnetic force (hereinafter referred to as the ‘second magnetic force’) between the second part 230B and the first magnetic body may include methods of applying different materials or contents to the first and second parts 230A, 230B, methods of making the thicknesses of the first and second parts 230A, 230B different, etc.

In order to facilitate design, assembly and connection, and to minimize the thickness of the actuator 200, it is desirable to configure the area of the surface facing the fourth magnet M4 differently so that the first magnetic force is smaller than the second magnetic force.

To this end, the area of the first part 230A of the yoke plate 230 facing the first magnetic body (fourth magnet M4) may be configured to be smaller than the area of the second part 230B of the yoke plate 230 facing the first magnetic body (fourth magnet M4).

Specifically, the first part 230A may include an open portion 231A, which is a space that does not generate a magnetic force with the fourth magnet M4, as illustrated in FIG. 11, etc.

If the first part 230A includes the open portion 231A as above, the area of the surface facing the fourth magnet M4 may be effectively reduced.

In addition, in this configuration, the area coupled with the housing 220 may be expanded, so that the yoke plate 230 may be more firmly fixed to the housing 220.

Preferably, if the open portion 231A is formed in the shape of a hole, during insert injection, the injection material flows into the open portion 231A, so that the yoke plate 230 may be fixed to the housing 220 with a higher coupling force.

For reference, A, A1, and A2 in FIG. 12 represent the range or region in which the vertical center of the fourth magnet M4 moves, and the graph on the right side of FIG. 12 represents the return force according to the vertical position of the fourth magnet M4, and the sign of the return force represents the direction component of the return force.

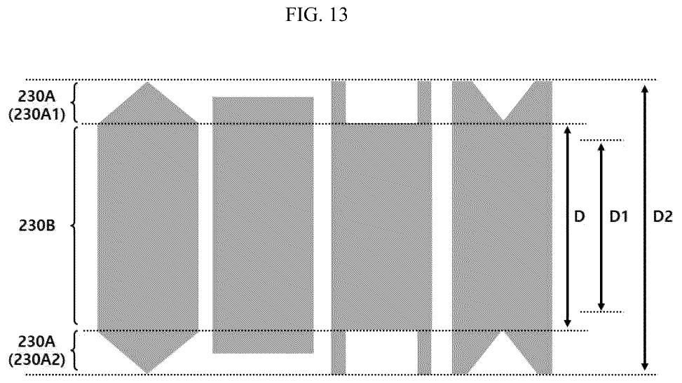

FIG. 13 is a drawing showing a yoke plate 230 according to other embodiments of the present disclosure.

The yoke plate 230 illustrated in FIG. 13 corresponds to an embodiment in which the area of the first part 230A facing the fourth magnet M4 is smaller than the area of the second part 230B facing the fourth magnet M4.

Considering the mechanical design tolerance, the driving precision for magnetic force control, and the physical interference between internal components, it may be desirable that the physically movable length (based on the optical axis direction) (D2) of the carrier 210 is set to be larger than the range (D1) over which the carrier 210 moves by control such as AF or zoom.

In this case, it is desirable that the total length (D) of the second part 230B in the optical axis direction is set to be equal to or less than the total length (D2) in the optical axis direction by which the fourth magnet M4 (first magnetic body) is physically movable, and to be equal to or greater than the total length (D1) in the optical axis direction by which the fourth magnet M4 moves by control such as AF or zoom.

In this configuration, the magnitude of the attractive force between the fourth magnet M4 and the yoke plate 230 is the same in the range where the AF or zoom control is applied, so that precise control such as AF may be achieved without applying a compensation algorithm.

For reference, D2 in FIG. 13 refers to the range in which the fourth magnet M4 moves based on the top and bottom (based on the optical axis direction) of the fourth magnet M4, and D1 refers to the range in which the fourth magnet M4 moves based on the center of the fourth magnet M4.

As illustrated in FIG. 13, the first upper part 230A1 of the first and fourth (from the left) yoke plates 230 may have a shape in which the size thereof becomes smaller as it goes up, and the first lower part 230A2 of the yoke plate 230 may have a shape in which the size thereof becomes smaller as it goes down.

If the first upper part 230A1 or the first lower portion part 230A2 has this shape, when the fourth magnet M4 moves to the upper portion (top) or the lower portion (bottom) of the yoke plate 230, the return force may be induced to act more effectively on the fourth magnet M4.

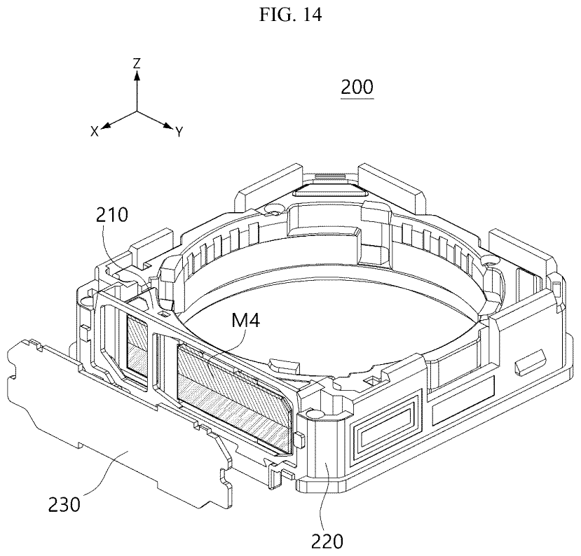

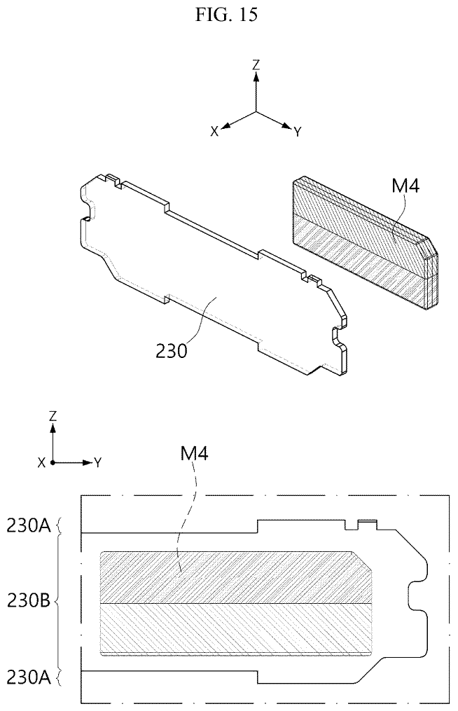

FIG. 14 is a drawing for illustrating an actuator 200 according to another embodiment of the present disclosure, and FIG. 15 is a drawing for illustrating the yoke plate 230 shown in FIG. 14.

The embodiment illustrated in the drawing corresponds to an embodiment in which the carrier 210 moving in the optical axis direction is provided on the outer side of the OIS carrier moving in a direction perpendicular to the optical axis.

In addition, this embodiment corresponds to a case where the magnet (previously referred to as the fourth magnet M4) that generates an attractive force with the yoke plate 230 provided in the housing 220 is a magnet that generate a driving force in relation to the AF coil.

The yoke plate 230 includes a first part 230A that faces the fourth magnet M4 at a position where the fourth magnet M4 is located at the upper portion (top) or the lower portion (bottom) (Z-axis direction) as shown in the drawing, and a second part 230B that faces the fourth magnet M4 at a position where the fourth magnet M4 is located at the middle portion.

In order to implement the technical idea of the present disclosure described above, in this embodiment, the area of the fourth magnet M4 facing the first part 230A is configured to be smaller than the area of the fourth magnet M4 facing the second part 230B.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

What is claimed is:

1. An actuator for a camera, comprising:
a carrier having a first magnetic body and configured to perform a linear movement;
a housing configured to support the linear movement of the carrier; and
a second magnetic body provided in the housing to face the first magnetic body and configured to generate an attractive force with the first magnetic body,
wherein the second magnetic body includes:
a first part configured to face the first magnetic body when the carrier is located at an upper portion or a lower portion based on a movement direction of the carrier; and
a second part which is a middle portion of the second magnetic body based on the movement direction of the carrier,
wherein a magnetic force between the first magnetic body and the first part is smaller than a magnetic force between the first magnetic body and the second part.

2. The actuator for a camera according to claim 1,
wherein an area of the first part facing the first magnetic body is smaller than an area of the second part facing the first magnetic body.

3. The actuator for a camera according to claim 1,
wherein the first part includes an open portion that does not generate a magnetic force with the first magnetic body.

4. The actuator for a camera according to claim 1,
wherein the first part includes:
a first upper part which is a top portion of the second magnetic body; and
a first lower part which is a bottom portion of the second magnetic body,
wherein the first upper part is formed in a shape that gets smaller as it goes up, and the first lower part is formed in a shape that gets smaller as it goes down.

5. The actuator for a camera according to claim 1,
wherein a total length of the second part based on the movement direction of the carrier is less than or equal to a total length by which the first magnetic body is physically movable and is greater than or equal to a total length by which the first magnetic body moves by AF or zoom control.

6. The actuator for a camera according to claim 1, further comprising:
a driving magnet provided in the carrier;
a driving coil provided in the housing to face the driving magnet; and
a ball arranged between the housing and the carrier,
wherein the first and second magnetic bodies are arranged to face each other with the ball interposed therebetween.
